(19) United States
(12) Patent Application Publication
(10) Pub. No.: US 2009/0195224 A1
(43) Pub. Date: Aug. 6, 2009

(54) Digital Excitation Control System Utilizing Self-Tuning PID Gains and an Associated Method of Use

(75) Inventor: Kiyong Kim, Collinsville, IL (US)

Correspondence Address: THOMPSON COBURN LLP, ONE US BANK PLAZA, SUITE 3500, ST LOUIS, MO, 63101, US

(73) Assignee: BASLER ELECTRIC COMPANY, Highland, IL (US)

(21) Appl. No.: 12/023,145

(22) Filed: Jan. 31, 2008

(51) Int. Cl. H02P 9/00

(52) U.S. Cl. 322/28; 322/36; 322/99

(57) ABSTRACT

A system and method for self-tuning a PID controller utilized with an exciter and generator, which includes a power source, an exciter electrically connected to the power source, a generator that is electrically energized by the exciter, and a processor that provides a PID controller that calculates system gain an estimated exciter time constant and an estimated generator time constant with a recursive least square with forgetting factor algorithm, wherein the estimated exciter time constant and the estimated generator time constant are utilized to calculate PID gains by the processor, wherein the processor includes a random input generator that is summed with the output of the PID controller as input to determine the PID gains using the estimated exciter time constant and the estimated generator time constant and the processor compares a digital value of rms generator voltage against a reference voltage as input into the PID controller.

### BACKGROUND OF THE INVENTION

An electrical generator typically operates by rotating a coil of wire relative to a magnetic field (or vice versa). In modern electrical generators, this magnetic field is typically generated using electromagnets known as field coils. An electrical current in these field coils provides the magnetic field necessary to induce an electrical current in the main generator coil. The current and voltage output of the main generator depends on the current in the field coils. Thus, as the generator load changes, the magnetic field strength must be adjusted to maintain constant generator output. This is achieved by regulating the current in the field coils. As the load increases, the field strength must increase, and as the load decreases, the field strength must decrease. Thus, it is necessary to continuously regulate the current in the field coils.

In modern electrical generators, the electrical current in the field coils is provided by an exciter generator. Thus, the problem of regulating the main generator field strength is equivalent to regulating the output of the exciter generator. The exciter generator includes its own exciter field coils. Therefore, the output of the exciter generator can be controlled by regulating the current supplied to the exciter field coils.

The output of a voltage regulator provides power to the exciter field coils. Therefore, the output of the voltage regulator controls the output of the exciter generator, and thereby controls the output of the main generator. The purpose of the voltage regulator is to maintain the output of the main generator at a constant voltage, known as the “set point”. The difference between the set point and the actual main generator output is “error”.

Many different types of voltage regulators have been proposed for these excitation systems. One of the most popular modern voltage regulator systems utilizes a Proportional, Integral, and Derivative (“PID”) controller. A PID controller monitors the output of the generator and adjusts its own output depending on sensed generator output. As the name implies, the PID controller provides three types of control: proportional, integral, and derivative. Proportional control responds in proportion to the error. Integral control responds to the sum of previous errors. Derivative control responds to the rate of change of the error.

Referring now to FIG. 1, the basic block diagram of a PID block utilized in the automatic voltage regulator control loop is generally indicated by numeral 10. In addition to the PID block 10, the system loop gain K_{G} provides an adjustable term to compensate for variations in system input voltage to a power converting bridge. The transfer function Gc(s) of the PID controller may be expressed as

$${G}_{C} = {K}_{G} {V}_{P} ( {K}_{P} + \frac{{K}_{I}}{s} + \frac{{K}_{D} s}{1 + {T}_{D} s} ) ,$$

where K_{G} is loop gain, K_{P} is proportional gain, K_{I} is integral gain, K_{D} is derivative gain, V_{P} is power input voltage, T_{D} is derivative filter time constant and “s” is the Laplace operator.

The generator reference voltage V_{REF} 12 is summed 16 with the sensed voltage V_{C} 14 to form a voltage error signal. It is multiplied by the loop gain K_{G} 18. This scaled voltage error signal is utilized to generate three terms with corresponding gains, the proportional gain K_{P} 20, the integral gain K_{I} 22 and the derivative gain K_{D} 24. The integral term is limited by an upper summation value of max field forcing V_{RLMT} 26 divided by power input voltage V_{P} 28. The integral term and the derivative term are summed together 30 and then this summation is summed 32 with the proportional term. This summed value 32 is multiplied by the power input voltage V_{P} 34 to provide the voltage regulator output V_{R} 36.

The controller gains are determined using several excitation system parameters, such as voltage loop gain, open circuit time constants, and so forth. These parameters vary not only with the system loading conditions, as generally illustrated by numeral 38 in FIG. 2, but also system configuration dependent gains such as power input voltage.

In general, since the calculation of loop gain requires several excitation system parameters that are generally not available during commissioning, e.g., specifically the machine time constant, this lack of information increases commissioning time. Many times there is no access to the actual equipment but only to a manufacturer's data sheet, or some typical data set. For this case, the only available measurement to check excitation system performance is the combined response of exciter and generator as generally illustrated by numeral 40 in FIG. 3. Under these conditions, commissioning a new voltage regulator becomes a challenging task.

The relative weights of these three types of control in a PID controller must be set for accurate control of the generator output. Choosing these relative weights is known as “tuning” the PID controller. The goal is to achieve a “fast” excitation system that will respond quickly to an error but will not produce overshoot or undershoot. Overshoot occurs when the controller provides too much current, thereby causing a “spike” in main generator output. Undershoot occurs when the controller provides too little current, thereby causing a “dip” in main generator output. A poorly tuned PID controller will result in poor performance, e.g., overshoot, undershoot, or slow response time. A well-tuned excitation system offers benefits in overall operating performance by responding quickly to transient conditions such as system faults, disturbances, and motor starting. After a fault, a fast excitation system will improve transient stability by holding up the system voltage and providing positive damping to system oscillations. A well-tuned excitation system will minimize voltage overshoot after a disturbance and avoid the nuisance tripping of generator protection circuits. When a motor is powered by a generator, the motor presents a large load while the motor is starting, which can cause the generator output voltage to dip. A dip in generator output voltage can cause damage to the motor as the motor will increase its current consumption and heats up to do resistive heating within the motor. During motor starting, a fast excitation system will minimize the generator voltage dip and reduce the heating losses of the motor.

One method of tuning the PID controller is by trial-and-error. Trial-and-error is tedious and adds significantly to commissioning time. Consequently, several automatic “self-tuning” algorithms have been proposed.

One difficulty in regulating the voltage output of a generator arises due to the inductive properties of a coil of wire, such as a field coil winding. Since the excitation system and the generator contain inductive coils, there is a time delay between a change in output voltage from the voltage regulator and the corresponding change in generator output voltage. The length of this delay is determined by “time constant”. The main time constants of concern are the exciter time constant and the generator time constant. In the present invention, these time constants are estimated and taken into account when tuning the PID controller, thereby achieving improved performance. The present invention is directed to overcoming one or more of the problems set forth above.

### SUMMARY OF INVENTION

The present invention relates to an automatic algorithm for tuning a PID controller using a Recursive Least Square algorithm with a forgetting factor. A new algorithm for estimating exciter and generator time constants is disclosed herein.

In one aspect of the present invention, the calculated PID gains are fixed during commissioning. No further tuning is conducted during normal operation. The benefit of this approach is that no supervision is needed to prevent undesirable responses caused by a transient behavior of the PID gain estimation.

In an aspect of the present invention, a system for self-tuning a PID controller utilized with an exciter and generator is disclosed. The system includes a power source, an exciter electrically connected to the power source, a generator that is electrically energized by the exciter, and a processor that provides a PID controller that calculates system gain, an estimated exciter time constant and an estimated generator time constant using a recursive least square with forgetting factor algorithm, wherein the estimated exciter time constant and the estimated generator time constant are utilized to calculate PID gains by the processor.

In another aspect of the present invention, a system for self-tuning a PID controller utilized with an exciter and generator is disclosed. The system includes a power source, an exciter electrically connected to the power source, a generator that is electrically energized by the exciter, and a processor that provides a PID controller that calculates system gain, an estimated exciter time constant and an estimated generator time constant with a recursive least square with forgetting factor algorithm, wherein the estimated exciter time constant and the estimated generator time constant are utilized to calculate PID gains by the processor, wherein the processor includes a random input generator that is summed with the output of the PID controller as input to determine the PID gains using the estimated exciter time constant and the estimated generator time constant and the processor compares a digital value of rms generator voltage against a reference voltage as input into the PID controller.

In yet another aspect of the present invention, a system for self-tuning a PID controller utilized with an exciter and generator is disclosed. The system includes a power source, an exciter electrically connected to the power source, a generator that is electrically energized by the exciter, a first processor that provides a PID controller that calculates system gain, an estimated exciter time constant and an estimated generator time constant with a recursive least square with forgetting factor algorithm, wherein the estimated exciter time constant and the estimated generator time constant are utilized to calculate PID gains by the first processor, wherein the processor includes a random input generator that is summed with the output of the PID controller as input to determine the PID gains using the estimated exciter time constant and the estimated generator time constant and the first processor compares a digital value of rms generator voltage against a reference voltage as input into the PID controller, a second processor controls a self-tuning mode and obtains operating status while obtaining the estimated exciter time constant, the estimated generator time constant and the PID gains from the first processor through a communications link, and an electronic display that is electrically connected to the second processor for displaying at least one of the operating status, diagnostic functions, the system gain, the estimated exciter time constant, the estimated generator time constant, and a step response with real time monitoring.

In still yet another aspect of the present invention, a method for self-tuning a PID controller utilized with an exciter and generator is disclosed. The method includes calculating system gain with a processor that also operates as a PID controller, calculating an estimated exciter time constant and an estimated generator time constant with a recursive least square with forgetting factor algorithm with the processor, utilizing the estimated exciter time constant and the estimated generator time constant to calculate PID gains with the processor, self-tuning the PID gains, with the processor, to control exciter field voltage to an exciter, wherein the exciter electrically connected to the power source and a generator is electrically energized by the exciter.

In another aspect of the present invention, a method for self-tuning a PID controller utilized with an exciter and generator is disclosed. The method includes calculating system gain with a first processor that also operates as a PID controller, calculating an estimated exciter time constant and an estimated generator time constant with a recursive least square with forgetting factor algorithm with the first processor, utilizing the estimated exciter time constant and the estimated generator time constant to calculate PID gains with the first processor, self-tuning the PID gains, with the first processor, to control exciter field voltage to an exciter, wherein the exciter electrically connected to the power source and a generator is electrically energized by the exciter, controlling a self-tuning mode and obtaining operating status while obtaining the estimated exciter time constant, the estimated generator time constant and the PID gains from the first processor through a communications link with a second processor, and displaying at least one of the operating status, diagnostic functions, the system gain, the estimated exciter time constant, the estimated generator time constant, and a step response with real time monitoring on an electronic display that is electrically connected to the second processor.

These are merely some of the innumerable aspects of the present invention and should not be deemed an all-inclusive listing of the innumerable aspects associated with the present invention.

### BRIEF DESCRIPTION OF THE DRAWINGS

For a better understanding of the present invention, reference may be made to accompanying drawings, in which:

FIG. 1 depicts a block diagram representation of a PID controller utilized in an automatic voltage regulator;

FIG. 2 is a graphical representation of a generator saturation curve illustrating generator gain;

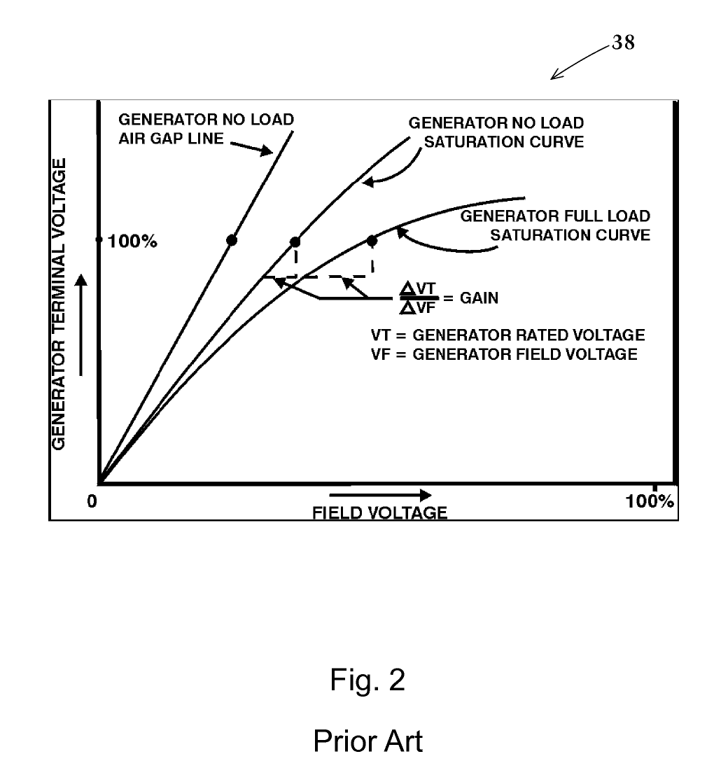

FIG. 3 is a graphical representation of a phase shift in degrees for an exciter field, a generator field, and the summation of the phase shift for the exciter field and the generator field in relationship to machine/regulator oscillating frequency;

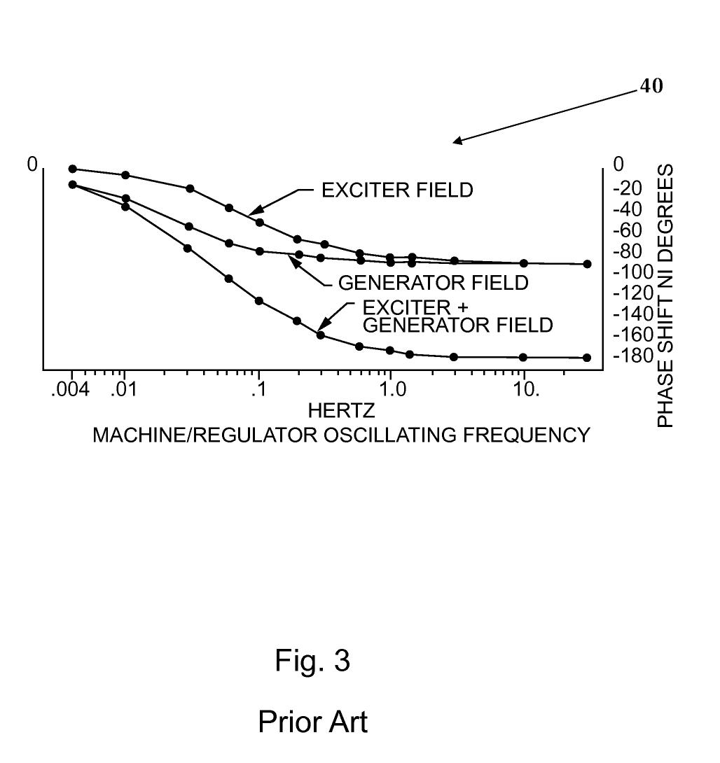

FIG. 4 depicts a block diagram representation for an estimation algorithm that relies on both exciter and generator dynamics;

FIG. 5 shows a block diagram of an exemplary embodiment of the present invention utilizing at least one processor, input/output, an exciter, a generator and an associated power supply;

FIG. 6 is a graphical user interface showing estimation of loop gain;

FIG. 7 is a graphical user interface showing estimation of time constants;

FIG. 8 is a graphical user interface showing an automatic voltage regulator response with default values; and

FIG. 9 is a graphical user interface showing self-tuned PID gains.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well known methods, procedures, and components have not been described in detail so as not to obscure the present invention.

A self-tuning recursive least squares algorithm is represented as follows:
K_{S} represents the system gain.
T_{E} represents the exciter time constant.
T_{do} represents the generator time constant.
   The plant transfer function G(s) can then be expressed as:

$$G ( s ) = {K}_{S} ( \frac{1}{1 + {sT}_{E}} ) ( \frac{1}{1 + {sT}_{do}^{′}} )$$

When y(k) represents the generator output voltage at time sample k and u(k) represents the regulator output voltage at time sample k then the generator output can be expressed in a discrete form as:

y(k)=a₀+a₁y(k−1)+a₂y(k−2)+b₁u(k−1)+b₂u(k−2)

In recursive least square estimation, unknown parameters of a linear model are chosen in such a way that the sum of the squared errors between actually observed and computed generator voltage (y(k)) is at a minimum.

When α=[a₁a₂b₁b₂1] and φ^{T}(k)=[y(k−1) y(k−2) u(k−1) u(k−2) 1] then:

$$E ( α , n ) = {\sum }_{k = 1}^{n} {λ ( y ( k ) - {φ}^{T} ( k ) α )}^{2}$$

Solving for system parameter α yields:

$$\hat{α} ( k ) = {( {\sum }_{k = 1}^{n} φ ( k ) {φ}^{T} ( k ) )}^{- 1} ( {\sum }_{k = 1}^{n} φ ( k ) y ( k ) )$$

The recursive form of the above equation is given by:

$${L}_{k} = {P}_{k - 1} - {P}_{k - 1} {{φ}_{k} [ {φ}^{T} {kP}_{k - 1} {φ}_{k} + λ ]}^{- 1}$$

$${P}_{k} = \frac{1}{λ} ( I - {L}_{k} {φ}^{T} k ) {P}_{k - 1}$$

$${\hat{α}}_{k} = {\hat{α}}_{k - 1} + {L}_{k} [ {y}_{k} - {φ}^{T} k {\hat{α}}_{k - 1} ]$$

where λ is a forgetting factor.

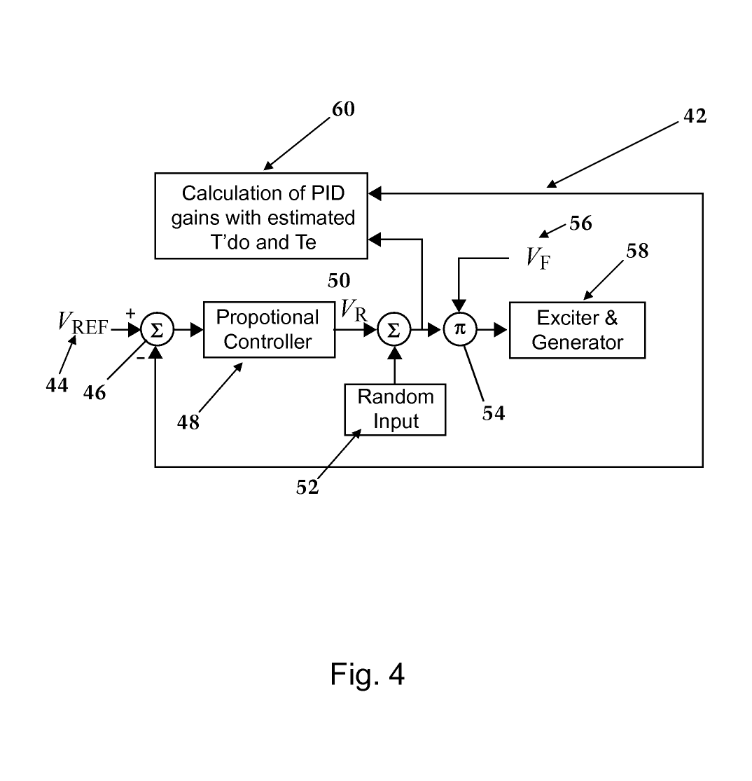

Referring now to FIG. 4, a block diagram of the Recursive Least Squares scheme is generally indicated by numeral 42. The closed loop control system with a proportional (“P”) gain controller 48 is utilized. This provides for stable operation in the linear region rather than the saturation region. A random input 52 is provided which operates as a disturbance is summed 50 with the generator voltage output V_{R} from the proportional (“P”) gain controller 48. This summation 50 is provided as input to calculate the values of the exciter time constant, i.e., Tₑ, and the generator time constant, i.e., T′_{do} 60. Also, summation 50 is multiplied 54 by the power input voltage V_{P} 56 and then provided to the exciter and generator 58. The generator terminal voltage from the exciter and generator 58 is also provided as input to calculate the values of the exciter time constant, i.e., Tₑ, and the generator time constant, i.e., T′_{do} 60. The generator terminal voltage from the exciter and generator 58 is also summed 46 with generator voltage Reference (“V_{REF}”) 44 that provides input to the proportional gain (“P”) gain controller 48. The proportional gain is selected at a predetermined value, e.g., eight (8) p.u. to regulate at eighty five percent (85%) of rated voltage.

The next step is to calculate system gain. If V_{R} represents the output voltage of the PID and V_{T} represents the generator output voltage then the steps for calculating the system loop gain K_{G} are:
1. check residual voltage with zero regulator output;
2. find open loop output corresponding to residual voltage;
3. find regulator output corresponding to nominal generator voltage; and
4. calculate loop gain according to the following equation: K_{G}=V_{R}/V_{T}

The exciter and generator time constants are then calculated. The generator time constant (T′_{do}) is calculated based on estimated parameters, αₖ₁ and α_{k2,} obtained by Recursive Least Squares according to the following equation:

$${\hat{T}}_{do}^{′} = - {T}_{S} / log ( \frac{{α}_{k 1} + \sqrt{{α}_{k 1}^{2} + 4 {α}_{k 2}}}{2} )$$

The exciter time constant T′_{do} is calculated based on estimated parameters, αₖ₁ and α_{k2,} obtained by Recursive Least Squares according to the following equation:

$${\hat{T}}_{exc}^{′} = - {T}_{S} / log ( \frac{{α}_{k 1} - \sqrt{{α}_{k 1}^{2} + 4 {α}_{k 2}}}{2} )$$

Upon calculation of the system gain and the exciter and generator time constants, the PID gains can be calculated. T_{D} represents the derivative filter time constant. To simplify the design of the PID controller, the following assumptions are made:

K_{S}=1;

T_{D}=0;

Thus, the plant transfer function G(s) is given as:

$$G ( s ) = ( \frac{1}{1 + {sT}_{E}} ) ( \frac{1}{1 + {sT}_{do}^{′}} )$$

There are two methods that can be utilized for designing the PID controller: (1) pole-zero cancellation; and (2) pole placement. In one embodiment of the present invention, pole-zero cancellation forces the two zeros resulting from the PID controller to cancel the two poles of the plant. The placement of zeros is achieved via appropriate choice of controller gains. The open-loop transfer function of the system becomes:

$${G}_{C} ( s ) \cdot G ( s ) = \frac{{K}_{D} ( {s}^{2} + \frac{{K}_{P}}{{K}_{D}} s + \frac{{K}_{I}}{{K}_{D}} )}{{T}_{do}^{′} {T}_{E} s ( s + \frac{1}{{T}_{do}^{′}} ) ( s + \frac{1}{{T}_{E}} )}$$

For pole-zero cancellation:

$$Let {K}_{I} = \frac{{K}_{D}}{{T}_{do}^{′} {T}_{E}}$$

$$Let {K}_{P} = {K}_{D} ( \frac{{T}_{do}^{′} + {T}_{E}}{{T}_{do}^{′} {T}_{E}} )$$

Thus the system transfer function is reduced to:

$${G}_{C} ( s ) \cdot G ( s ) = \frac{{K}_{D}}{{T}_{do}^{′} {T}_{E} s}$$

so that the closed loop transfer function can then be expressed as:

$$\frac{C ( s )}{R ( s )} = \frac{G ( s ) {G}_{C} ( s )}{1 + G ( s ) {G}_{C} ( s )} = \frac{{K}_{D} / {T}_{do}^{′} {T}_{e}}{s + {K}_{D} / {T}_{do}^{′} {T}_{e}}$$

The time response of the closed-loop system to a unit step input is as follows:

$$c ( t ) = 1 - {e}^{- \frac{{K}_{D}}{{T}_{do}^{′} {T}_{E}} t}$$

If tᵣ is the specified rise time, the value of K_{D} is obtained by:

$${K}_{D} = \frac{{T}_{do}^{′} {T}_{E} ln 9}{{t}_{r} \cdot {K}_{G}}$$

After calculating K_{D} according to this equation,

$${K}_{I} = \frac{{K}_{D}}{{T}_{do}^{′} {T}_{E}} and {K}_{P} = {K}_{D} ( \frac{{T}_{do}^{′} + {T}_{E}}{{T}_{do}^{′} {T}_{E}} )$$

can be used to calculate K_{P} and K_{I}.

In another embodiment of the present invention, pole placement is used to design the PID controller. In this method, the desired closed-loop pole locations are decided on the basis for meeting a transient response specification. In one embodiment, the design forces the overall closed-loop system to be a dominantly second-order system. Specifically, we force the two dominant closed-loop poles to be a complex conjugate pair, (s=−a±jb) resulting in an underdamped response. The third pole is chosen to be a real pole (s=c), and is placed so that the natural mode of response from it is five times faster than the dominant poles. The open loop transfer function is given as:

$${G}_{C} ( s ) G ( s ) = ( {K}_{P} + \frac{{K}_{I}}{s} + {K}_{D} s ) ( \frac{1}{1 + {sT}_{E}} ) ( \frac{1}{1 + {sT}_{do}^{′}} )$$

The PID controller gains K_{P}, K_{I}, and K_{D} are then analytically determined by solving the characteristic equation:

$$( {K}_{P} + \frac{{K}_{I}}{s} + {K}_{D} s ) ( \frac{1}{1 + {sT}_{E}} ) ( \frac{1}{1 + {sT}_{do}^{′}} ) = - 1$$

Three values of s are then used:

s=−a+jb

s=−a−jb

s=−c

Thus, there are three equations and three unknowns. The value of s for each of Equations s=−a+jb, s=−a−jb and s=−c can be substituted into

$$( {K}_{P} + \frac{{K}_{I}}{s} + {K}_{D} s ) ( \frac{1}{1 + {sT}_{E}} ) ( \frac{1}{1 + {sT}_{do}^{′}} ) = - 1$$

which provides the three equations. The three unknowns are K_{P}, K_{I}, and K_{D}. Therefore, it is possible to solve these three equations for K_{P}, K_{I}, and K_{D}.

Preferably, but not necessarily, the above equations are implemented with a PID controller using a voltage regulator developed for small size generator set. It consists of micro processor and signal conditioning circuits for generator voltage and PWM controlled regulator output. Preferably, but not necessarily, the generator voltage can be sampled with sixteen (16) bits resolution after anti-aliasing filters. The rms calculation of generator voltage can then be calculated on a predetermined period, e.g., every quarter cycle. Moreover, the self-tuning algorithm can be updated on a predetermined time period, e.g., every 200 milliseconds. When the self-tuning mode is activated by the user, the voltage regulator estimates a set of desired PID gains based on estimated time constants. The amplitude of the regulator output is then adjusted to maintain the voltage regulation in a linear region, which is a predetermined percentage of the rated generator voltage, e.g., 80%. This adjusted amplitude of regulator output is obtained during calculation of the system gain K_{G}.

For a simple user interface to digital voltage regulator with self-tuning feature, a personal computer (“PC”) program can be implemented on any of a wide variety of processors. The following illustrative, but nonlimiting, functions that can be implemented in the software program include: basic diagnostic functions (wiring and metering calibration); estimate the loop gain of the closed loop with PI controller; estimate generator and exciter time constants using Recursive Least Squares (“RLS”); calculate PID controller gains using estimated time constants (Tₑ and T_{do}); and step response with real-time monitoring.

Therefore, a field engineer is able to activate a self-tuning mode utilizing this software program. This software program is able to determine PID gains based on rising time and estimated parameters (system gain and exciter/generator time constants) using either a pole-zero cancellation method or a pole placement design method.

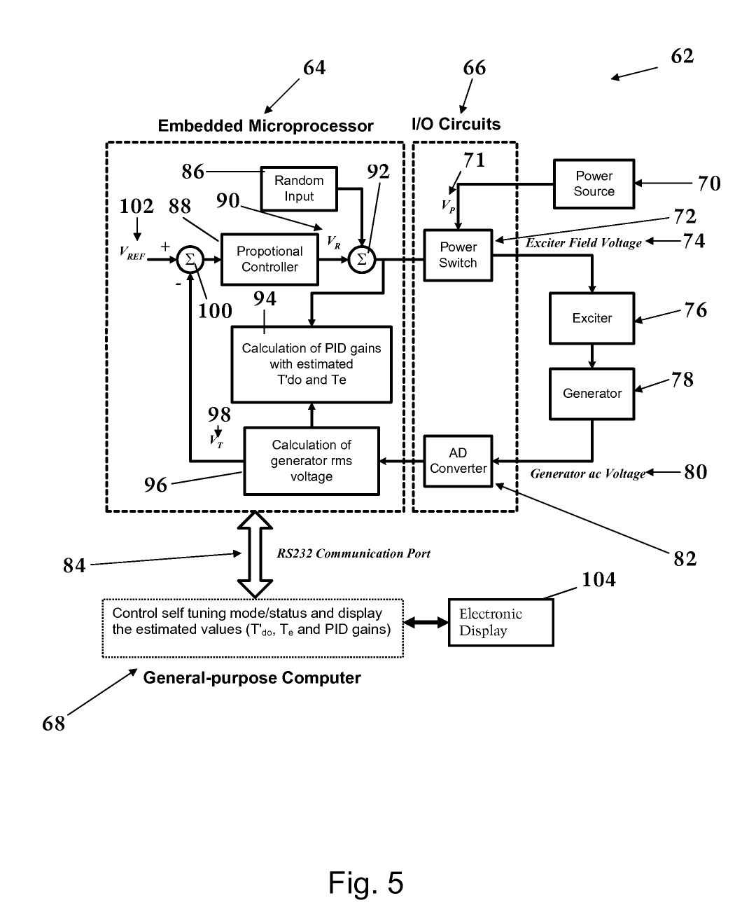

FIG. 5 illustrates a block diagram of an exemplary embodiment of the present invention and is generally indicated by numeral 62. I/O (Input/Output) circuitry 66 provides the interface between a first processor 64 and the heavy equipment, i.e., a power source 70, an exciter 76 and a generator 78 (Exciter/Generator/Power Source). The I/O circuitry 66 includes a power switch 72 and an analog-to-digital (“AD”) converter 82. The power source 70 provides power input voltage V_{P} 71 to the power switch 72. The power switch 72 is controlled by the first processor 64. A wide variety of computing devices may be utilized for the first processor 64, e.g., computers, controllers, and so forth. A preferred embodiment for the first processor 64 includes an embedded microprocessor. The power switch 72 also provides exciter field voltage 74 to the field coils of the exciter 76. The exciter 76 provides power to the field coils of generator 78. The a.c. output voltage 80 of generator 78 is connected to the analog-to-digital (“AD”) converter 82. The analog-to-digital (“AD”) converter 82 converts the input voltage level into a digital value which is passed on to the first processor 64. This digital value is then calculated 96, by the first processor 64, as a generator rms voltage, V_{T} 98. Optionally, the analog-to-digital (“AD”) converter 82 could be contained within the first processor 64.

The first processor 64 is loaded with a generator output voltage set point labelled V_{REF} 102. The first processor 64 calculates the error 100 as the difference between the voltage set point V_{REF} 102 and the sensed generator rms voltage, V_{T} 98 from the analog-to-digital (“AD”) converter 82. The first processor 64 is programmed to implement a PID controller 88. The first processor 64 is further programmed to calculate the estimated exciter time constant, i.e., Tₑ, and the generator time constant, i.e., T′_{do}, 94 as described above with input 96 involving the sensed generator rms voltage, V_{T} 98. The voltage regulator output V_{R} 90 from the PID controller 88 is summed 92 with a random input 86. This summation 92 is provided as input to both the power switch 72 as well as the calculations for the estimated exciter time constant, i.e., Tₑ, and the generator time constant, i.e., T′_{do}, 94. The first processor 64 is further programmed to calculate the PID gain values based on the estimated time constants, using either the pole-zero method or pole placement method as described above.

There is a second processor 68 that is connected to the first processor 64 through electronic communication link 84, e.g., RS 232 Communication Port. A variety of electronic communication protocols could be used, and RS 232 is merely one example. A wide variety of computing devices may be utilized for the second processor 68, e.g., computers, controllers, microprocessors and so forth. A preferred embodiment for the second processor 68 includes a general purpose microprocessor. The second processor 68 via the electronic communication link 84 allows the user of the second processor 68 to initiate the self-tuning mode, and to show on an electronic display 104 the estimated time constants and/or PID gain values. Any of a wide variety of electronic displays can suffice for the electronic display 104. Optionally, second processor 68 can calculate the exciter and generator time constants and PID gain values, and communicate these values to the first processor 64. However, both the first processor 64 and the second processor 68 can be combined as a single processing mechanism and either embedded or located away from the exciter and generator.

As an illustrative, but nonlimiting example, performance of self-tuning algorithm is tested using the Diesel-Generating Set, which consists of a 75 kW, 208 Vac, 1800 RPM, 3 φ synchronous generator. The excitation for this generator is provided by a permanent magnet generator (“PMG”) excited 0.3 Amp, 7 Vdc, ac exciter at no load. Evaluation of system performance begins by performing voltage step responses to examine the behavior of the excitation system connected to the generator.

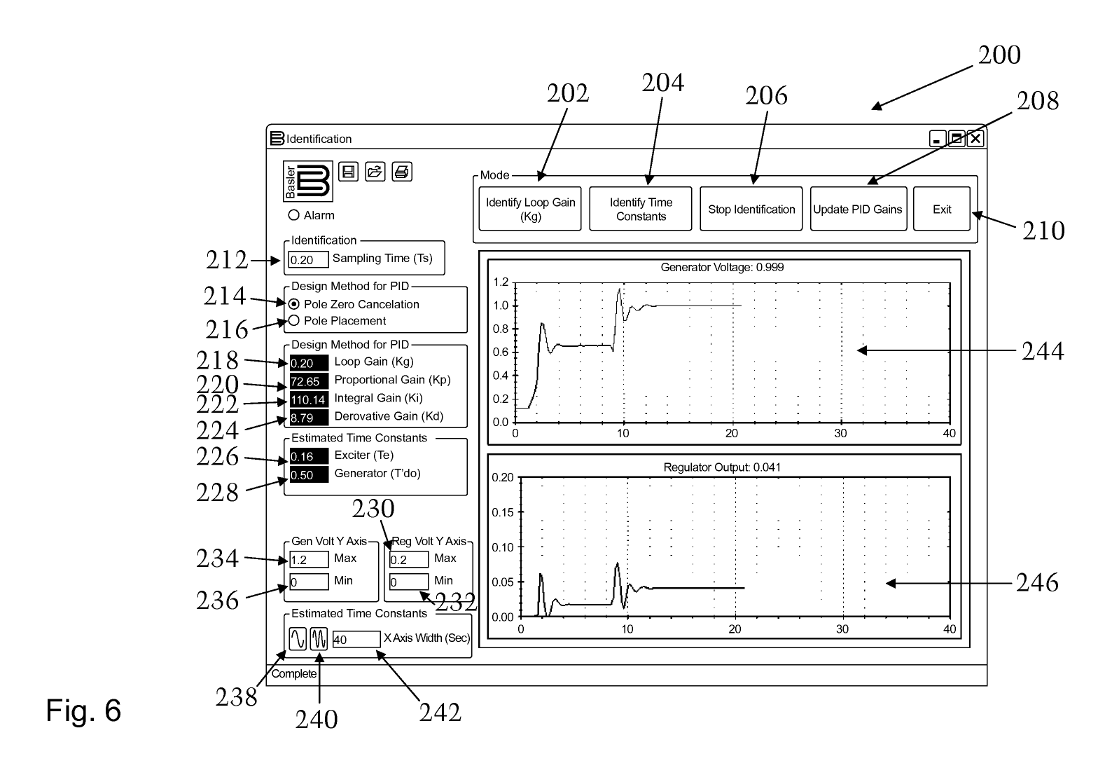

As shown in FIG. 6, a graphical user interface is generally indicated by numeral 200. This graphical user interface 200 appears on the electronic display 104, as shown in FIG. 5. Referring again to FIG. 6, there are five modes which include: identifying loop gain K_{G} 202; identifying time constants 204; stop identification 206; updating PID gains 208; and a software program exit function 210. For identifying loop gain 202, there is an input for identification of sampling time 212. There is a click-on input 214 for pole zero cancellation as a design method for a PID controller and a click-on input 216 for pole placement as a design method for a PID controller.

For calculated PID, there are four outputs that include: loop gain K_{G} 218; proportional gain K_{P} 220; integral gain K_{I} 222; and derivative gain K_{D} 224. Additional outputs include estimated time constants for the exciter Tₑ 226 and the generator T′_{do} 228. There are a series of inputs for creating graphical representations. These include a maximum value for the generator voltage on the y-axis 234; a minimum value for the generator voltage on the y-axis 236; a maximum value for the regulator voltage on the y-axis 230; and a minimum value for the regulator voltage on the y-axis 232. There is a graphical output icon 238 for extending a width of the x-axis and a graphical output icon 240 for reducing a width of the x-axis. There is also an input for a width of the x-axis in seconds 242. There is a graphical representation of generator voltage 244 and of regulator output 246.

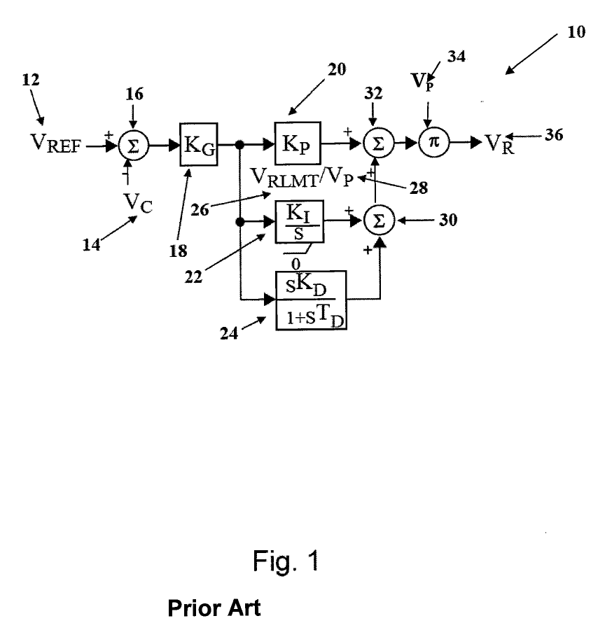

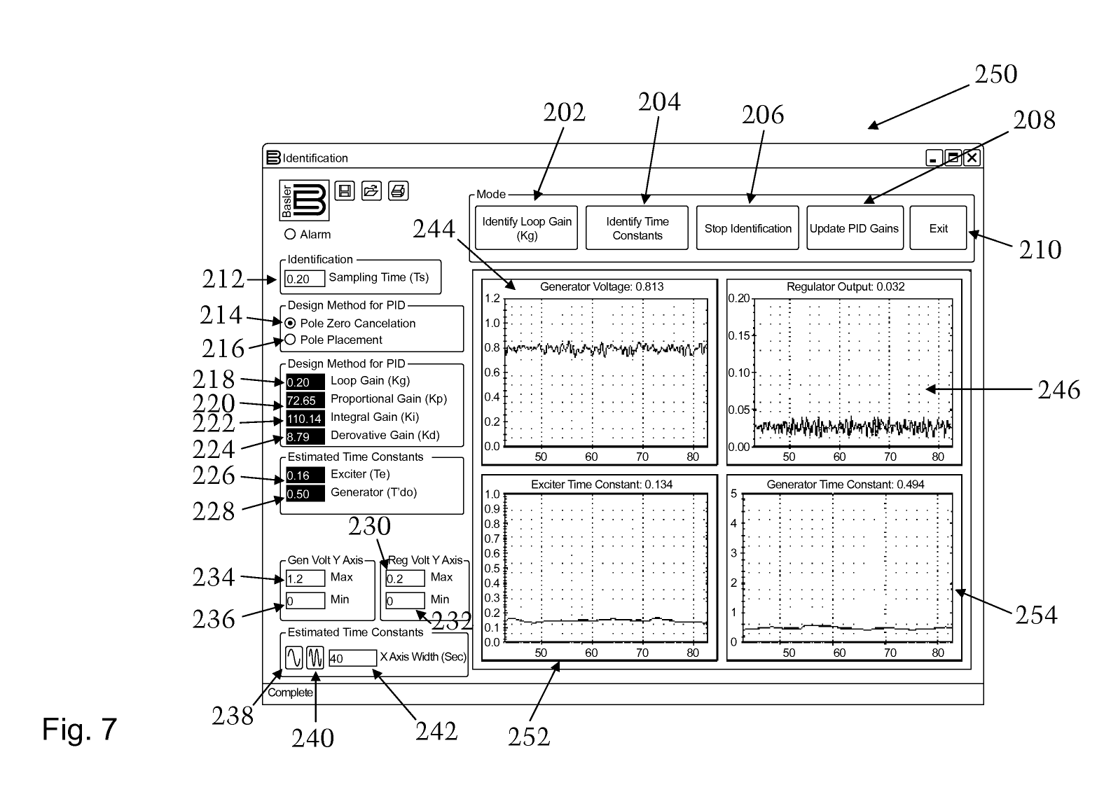

This software program monitors system and estimated parameters continuously. Since exciter and generator time constants are not available, factory PID gains (K_{P}=30, K_{I}=150, K_{D}=2, and T_{D}=0.08) were selected. These gains are compared with self-tuned gains in voltage step response. The system loop gain (K_{G}) was selected as three (3) for this case. A trial and error method was used to get a desirable gain. This commission time was eliminated with digital voltage regulator with self-tuning feature. The software program designed for self-tuning features in the self-tuning mode is activated and this self-tuning mode determines PID gains based on rising time and estimated parameters (system gain and exciter/generator time constants) using pole-zero cancellation method (K_{P}=69, K_{I}=110, and K_{D}=7). The time constant for the derivative block 24 in FIG. 1 was selected as T_{D}=0.03 to reduce the noise effect. FIG. 7, generally indicated by numeral 250, is the same graphical user interface as shown in FIG. 6 with the exception of a graphical representation of a time constant for the exciter Tₑ 252 and a graphical representation of a time constant for the generator T′_{do} 254.

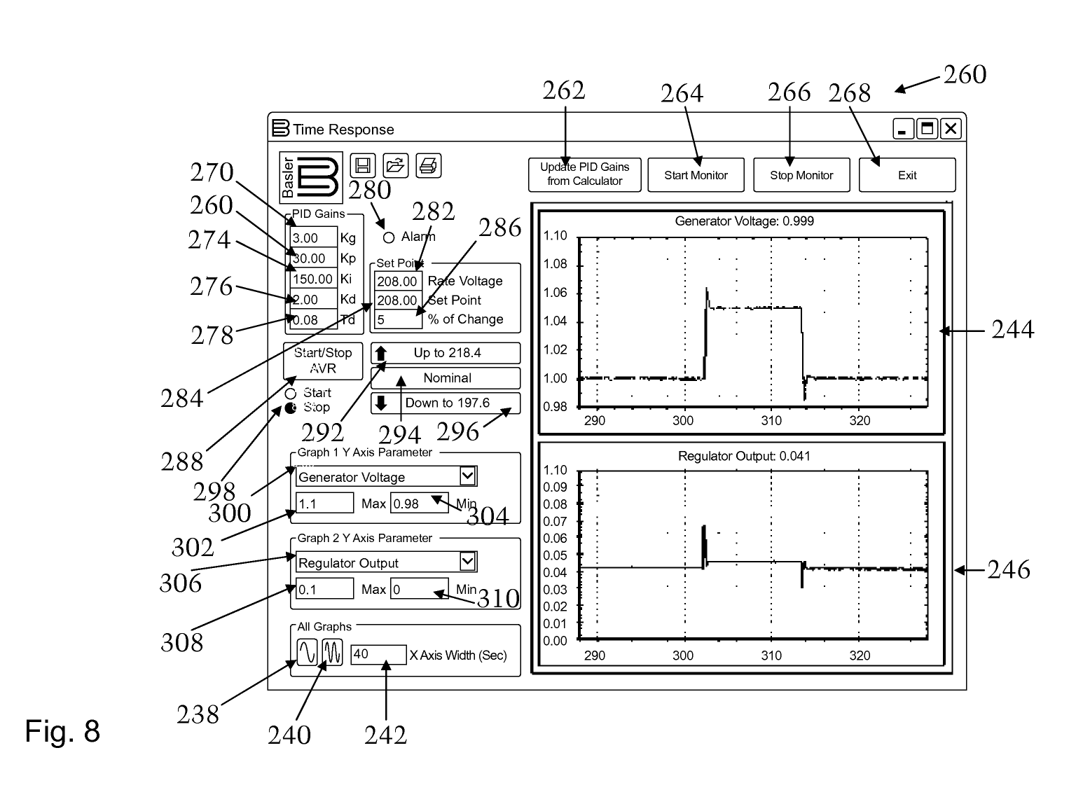

The updating of the PID gains feature 208, as shown as numeral 208 in FIG. 6, is shown in detail in FIG. 8 and is generally indicated by numeral 260. There are four push button feature icons that include: update PID gains from calculator 262; start monitor 264; stop monitor 266; and an exit function 268. There are five inputs for PID gains that include: loop gain K_{G} 270; proportional gain K_{P} 272; integral gain K_{I} 274; derivative gain K_{D} 276 and the derivative filter time constant T_{D} 278. There is also a push button icon 288 to stop and start the automatic voltage regulator.

There is an indicator 280 to indicate an alarm condition as well as an indicator 298 of whether the automatic voltage regulator is either stopped or started. Additionally, there is an input for rated voltage 282, set point 284, and percent (%) of change 286. Moreover, a push button icon 292 is used to increase the automatic voltage regulator to an upper predetermined value, e.g., 218.4, a push button icon 294 to operate the automatic voltage regulator at a nominal value and a push button icon 296 to decrease the automatic voltage regulator to a lower predetermined value, e.g., 197.6.

A drop-down input 300 for a first graph is used to graph parameters on the Y-axis, e.g., generator voltage. There is an input for both a maximum value 302 and a minimum value 304. There is a drop-down input 306 for a second graph to graph parameters on the Y-axis 300, e.g., regulator voltage. There is an input for both a maximum value 308 and a minimum value 310. There is a graphical output icon 238 for extending a width of the x-axis and a graphical output icon 240 for reducing a width of the x-axis. There is also an input for a width of the x-axis in seconds 242. There is a graphical representation of generator voltage 244 and of regulator output 246. This is the automatic voltage regulator response utilizing default values, which indicates a large overshoot which is caused by improper gains.

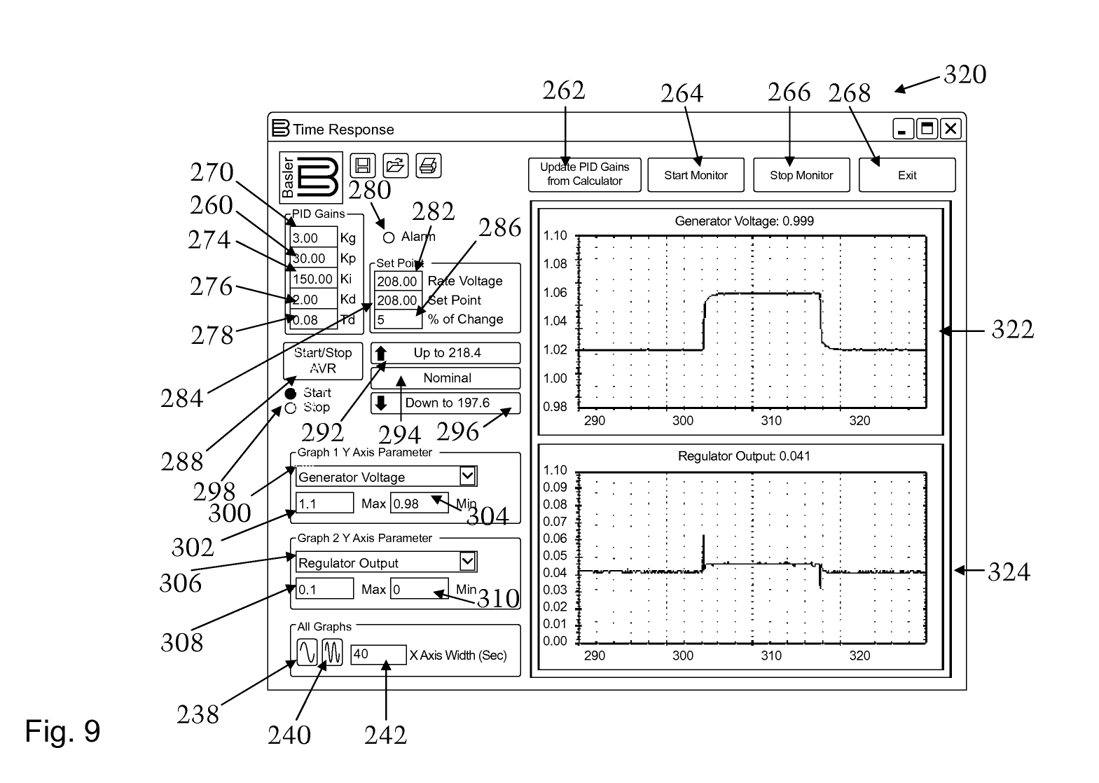

FIG. 9, generally indicated by numeral 320, is the same graphical user interface as shown in FIG. 8 with the exception that the graphical representation of generator voltage 322 and regulator output 324 reflects self-tuned PID gains that provide a fast response with no overshoot.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

1. A system for self-tuning a PID controller utilized with an exciter and generator comprising:
a power source;
an exciter electrically connected to the power source;
a generator that is electrically energized by the exciter; and
a processor that provides a PID controller that calculates system gain, an estimated exciter time constant and an estimated generator time constant using a recursive least square with forgetting factor algorithm, wherein the estimated exciter time constant and the estimated generator time constant are utilized to calculate PID gains by the processor.

2. The system for self-tuning a PID controller utilized with an exciter and generator according to claim 1, further includes a random input generator that is summed with the output of the PID controller as input to determine the PID gains using the estimated exciter time constant and the estimated generator time constant with the processor.

3. The system for self-tuning a PID controller utilized with an exciter and generator according to claim 1, wherein the PID controller receives as input a comparison of a digital value of rms generator voltage against a reference voltage.

4. The system for self-tuning a PID controller utilized with an exciter and generator according to claim 3, further includes an analog-to-digital converter to convert an analog generator a.c. voltage to the digital value of rms generator voltage.

5. The system for self-tuning a PID controller utilized with an exciter and generator according to claim 1, further includes a switch that is electrically connected to the power source, the exciter and the processor to regulate voltage to the exciter.

6. The system for self-tuning a PID controller utilized with an exciter and generator according to claim 1, wherein the PID controller utilizes pole zero cancellation.

7. The system for self-tuning a PID controller utilized with an exciter and generator according to claim 1, wherein the PID controller utilizes pole placement.

8. A system for self-tuning a PID controller utilized with an exciter and generator comprising:
a power source;
an exciter electrically connected to the power source;
a generator that is electrically energized by the exciter; and
a processor that provides a PID controller that calculates system gain, an estimated exciter time constant and an estimated generator time constant with a recursive least square with forgetting factor algorithm, wherein the estimated exciter time constant and the estimated generator time constant are utilized to calculate PID gains by the processor, wherein the processor includes a random input generator that is summed with the output of the PID controller as input to determine the PID gains using the estimated exciter time constant and the estimated generator time constant and the processor compares a digital value of rms generator voltage against a reference voltage as input into the PID controller.

9. The system for self-tuning a PID controller utilized with an exciter and generator according to claim 8, further includes an analog-to-digital converter to convert an analog generator a.c. voltage to the digital value of rms generator voltage.

10. The system for self-tuning a PID controller utilized with an exciter and generator according to claim 8, further includes a switch that is electrically connected to the power source, the exciter and the processor to regulate voltage to the exciter.

11. The system for self-tuning a PID controller utilized with an exciter and generator according to claim 8, wherein the processor performs diagnostic functions.

12. The system for self-tuning a PID controller utilized with an exciter and generator according to claim 8, wherein the processor provides real time monitoring of a step response.

13. The system for self-tuning a PID controller utilized with an exciter and generator according to claim 8, wherein the processor performs diagnostic functions and provides real time monitoring of a step response.

14. The system for self-tuning a PID controller utilized with an exciter and generator according to claim 8, further includes an electronic display for showing at least one of the system gain, the estimated exciter time constant, the estimated generator time constant and the PID gains.

15. The system for self-tuning a PID controller utilized with an exciter and generator according to claim 13, further includes an electronic display for showing at least one of the diagnostic functions and the real time monitoring of a step response.

16. A system for self-tuning a PID controller utilized with an exciter and generator comprising:
a power source;
an exciter electrically connected to the power source;
a generator that is electrically energized by the exciter;
a first processor that provides a PID controller that calculates system gain, an estimated exciter time constant and an estimated generator time constant with a recursive least square with forgetting factor algorithm, wherein the estimated exciter time constant and the estimated generator time constant are utilized to calculate PID gains by the first processor, wherein the processor includes a random input generator that is summed with the output of the PID controller as input to determine the PID gains using the estimated exciter time constant and the estimated generator time constant and the first processor compares a digital value of rms generator voltage against a reference voltage as input into the PID controller;
a second processor controls a self-tuning mode and obtains operating status while obtaining the estimated exciter time constant, the estimated generator time constant and the PID gains from the first processor through a communications link; and
an electronic display that is electrically connected to the second processor for displaying at least one of the operating status, diagnostic functions, the system gain, the estimated exciter time constant, the estimated generator time constant, and a step response with real time monitoring.

17. The system for self-tuning a PID controller utilized with an exciter and generator according to claim 16, wherein the first processor is an embedded microprocessor.

18. The system for self-tuning a PID controller utilized with an exciter and generator according to claim 16, wherein the second processor is a general purpose computer.

19. A method for self-tuning a PID controller utilized with an exciter and generator comprising:
calculating system gain with a processor that also operates as a PID controller;
calculating an estimated exciter time constant and an estimated generator time constant with a recursive least square with forgetting factor algorithm with the processor;
utilizing the estimated exciter time constant and the estimated generator time constant to calculate PID gains with the processor;
self-tuning the PID gains, with the processor, to control exciter field voltage to an exciter, wherein the exciter electrically connected to the power source and a generator is electrically energized by the exciter.

20. The method for self-tuning a PID controller utilized with an exciter and generator according to claim 19, further includes utilizing a random input generator that is summed with the output of the PID controller as input to determine the PID gains using the estimated exciter time constant and the estimated generator time constant with the processor.

21. The method for self-tuning a PID controller utilized with an exciter and generator according to claim 19, further includes:
converting an analog a.c. generator voltage to the digital value of rms generator voltage with an analog-to-digital converter; and
comparing the digital value of rms generator voltage against a reference voltage as input into the PID controller associated with the processor.

22. The method for self-tuning a PID controller utilized with an exciter and generator according to claim 19, further includes utilizing a switch that is electrically connected to the power source, the exciter and the processor to regulate voltage to the exciter.

23. The method for self-tuning a PID controller utilized with an exciter and generator according to claim 19, further includes performing diagnostic functions and real time monitoring of a step response with the processor.

24. The method for self-tuning a PID controller utilized with an exciter and generator according to claim 19, further includes utilizing an electronic display for showing at least one of the system gain, the estimated exciter time constant, the estimated generator time constant, the PID gains, diagnostic functions and a real time monitoring of a step response.

25. A method for self-tuning a PID controller utilized with an exciter and generator comprising:
calculating system gain with a first processor that also operates as a PID controller;
calculating an estimated exciter time constant and an estimated generator time constant with a recursive least square with forgetting factor algorithm with the first processor;
utilizing the estimated exciter time constant and the estimated generator time constant to calculate PID gains with the first processor;
self-tuning the PID gains, with the first processor, to control exciter field voltage to an exciter, wherein the exciter electrically connected to the power source and a generator is electrically energized by the exciter;
controlling a self-tuning mode and obtaining operating status while obtaining the estimated exciter time constant, the estimated generator time constant and the PID gains from the first processor through a communications link with a second processor; and
displaying at least one of the operating status, diagnostic functions, the system gain, the estimated exciter time constant, the estimated generator time constant, and a step response with real time monitoring on an electronic display that is electrically connected to the second processor.
